(19) United States
(12) Patent Application Publication
(10) Pub. No.: US 2006/0228436 A1
(43) Pub. Date: Oct. 12, 2006

(54) Molding unit

(76) Inventor: Franz Xaver Gilg, Polling (DE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/397,484

(22) Filed: Apr. 4, 2006

(30) Foreign Application Priority Data
Apr. 8, 2005 (EP) 05 007 690.0-2307

(51) Int. Cl. B29C 45/00

(52) U.S. Cl. 425/191

(57) ABSTRACT

Molding apparatus for molding materials, in particular for molding lipstick leads, wherein said molding apparatus comprises multiple molds in which said materials to be molded are cast, wherein said molding apparatus comprises multiple units (1), wherein in each of said units (1) multiple molds are located and comprises means for removable fastening each of said units (1) to said molding apparatus as well as a corresponding molding unit and a corresponding method for molding materials with a corresponding mold.

### FIELD OF THE INVENTION

The present invention relates to a unit for multiple molds, a molding apparatus for molding materials with multiple of such units for multiple molds, as well as a method for exchanging molds in a molding apparatus by means of units for multiple molds.

### BACKGROUND OF THE INVENTION

In a molding apparatus for molding materials, in particular for molding lipstick leads, the material to be molded will be filled-in in individual molds in a hot and liquid condition by means of a filling station. Then, the filled-in material is cooled down in the molds by means of a cooling station and after the cooling down process, the material in a rigid condition is removed out of the mold by means of a demolding station.

In general, such a molding apparatus comprises a multiplicity of molds, which are, for example, arranged annular at the border of a pour crown. If other products should be produced, for example lipstick leads with other dimensions, the molds must be exchanged. In addition, it may be necessary to exchange the molds if for other products an other demolding mechanism should be used. For example, this may be the case if another material with other properties should be used.

However, exchanging the molds is very time consuming and leads to long standstill times of the molding apparatus.

Therefore, the object of the present invention is to provide a molding apparatus with which the standstill time during the exchange of the molds can be substantially reduced.

### SUMMARY OF THE INVENTION

According to the invention, this object is solved by a molding apparatus for molding materials according to claim 1, by a unit to be used in a molding apparatus according to claim 7 and by a corresponding method for exchanging molds in a molding apparatus.

The molding apparatus for molding materials, in particular for molding lipstick leads, comprises for that multiple molds, in which the materials to be molded are cast. In addition, the molding apparatus comprises multiple units, wherein in each of said units multiple molds are located. According to the invention, the molding apparatus comprises also means for removable/exchangeable fastening each of said units to said molding apparatus.

By means of a molding apparatus according to the invention, it is possible to substantially reduce the standstill time of a molding apparatus during the exchange of molds used so far (old molds) against molds to be used now (new molds). Whereas in the molding apparatus known in the prior art the exchange of molds could only be carried out when the molding apparatus is not used, with the molding apparatus according to the invention, the exchange of molds may be prepared in parallel to the use of the molding apparatus. For that, in a preparation step the new molds may be already located in corresponding units. As soon as the molding process with the old molds is finalized, only the units with the old molds attached to the molding apparatus must be exchanged against the already prepared units with the new molds. For that, the units and the molding apparatus comprise preferably corresponding means so that the exchange process can be carried out quick, precise and simple.

According to the invention, in each unit multiple molds are located. An arrangement with at least ten molds in each unit is preferred. Depending on the dimension of each of the molds, it is possible that substantially more molds may be placed in each unit. By this, the number of exchange actions during the exchange of the molds can be reduced at least in the dimension of ten.

For the molding apparatus is also important that the molds are precisely inserted in the molding apparatus. Only this can secure that the filling process and the demolding process is carried out as desired and enables an unspoiled object. By means of a molding apparatus according to the invention, the precise inserting of the multiplicity of molds need not be carried out anymore under the time pressure of the standstill of the complete molding apparatus. According to the invention, the maybe complicated inserting of the molds can be carried out during the use of the molding apparatus, since the molds are not inserted in the molding apparatus itself but into the unit. Alternatively, the molds can be permanently placed in the unit.

The units and the molding apparatus each comprise preferably means with which the units can be detached from the molding apparatus as quick as possible and as simple as possible. In addition, the means should enable a quick as possible, simple as possible, firm as possible and precise as possible attaching of the units to the molding apparatus. According to a first preferred embodiment, screws are used for that. In an alternative second embodiment, the units are removable fastened to the molding apparatus by means of a plug device.

In a further preferred embodiment, the unit comprises a chamber for the flowing through of, for example, a cooling fluid. The chamber is preferably arranged such that the cooling fluid flushes around the molds located in the unit as direct as possible and thereby the materials located in the molds are cooled down. In order to enable the flowing-through of the cooling fluid, the unit comprises preferably openings for the inflow and the outflow of the cooling fluid. For that, the molding apparatus itself comprises preferably corresponding openings, via which the cooling fluid is feed to the unit or it is withdrawn out of the chamber.

In a further preferred embodiment, at least parts of the units have a low thermal conductivity. With this it can be prevented, for example, that the cooling fluid influences chambers of neighboring units. This may be important, for example, when the molds are preheated for the filling in by means of a warm fluid. Due to the use of an isolating material, a heating up of the cooling fluid in neighboring units may be prevented. In addition, such chambers could cool down the materials in the molds more effective. Therefore, preferably the units are made of plastics.

According to the invention, the object is also solved by a unit to be used in a molding apparatus for molding materials by means of molds. Such a molding apparatus may be used, for example, for producing lipstick leads. The unit comprises multiple openings for housing molds. The molds may be removable/exchangeable fasten or permanently fasten in these openings. In addition, the unit comprises means in order to removable fastening the unit to the molding apparatus. Examples for such means are a screw, a plug device, or corresponding openings in order to be attached by means of a screw or a plug device.

The unit comprises according to a preferred embodiment also a chamber, in particular for the flowing-through of a cooling fluid. With this cooling fluid, for example, the materials in the molds may be cooled down. Alternatively, also a warm fluid for heating up the molds may flow through the chamber. For that, the chamber comprises at least two openings for the inflow and the outflow of a corresponding fluid. The openings may be located such that the fluid may be delivered from the molding apparatus and may be dispensed again to the molding apparatus. Alternatively, at least one opening may feed the fluid to another unit or may receive the fluid from the other unit.

In a method according to the invention for exchanging of molds in a molding apparatus in a first step the units, which are attached to said molding apparatus, are detached from said molding apparatus, wherein said unit comprises first molds and in a second step units, which comprise second molds, are attached to the molding apparatus. The attaching of the units to the molding apparatus can be carried out with different attaching/fastening mechanism. Examples for that are screws or a plug device.

### BRIEF DESCRIPTION OF THE DRAWINGS

In the following, an embodiment of the invention is described by means of the accompanying drawings, in which

FIG. 1 shows an embodiment of a unit for multiple molds according to the invention, and

FIG. 2 shows a pour crown as it, for example, may be used in connection with the molding apparatus to which a unit for several molds is attached.

### DETAILED DESCRIPTION OF THE INVENTION

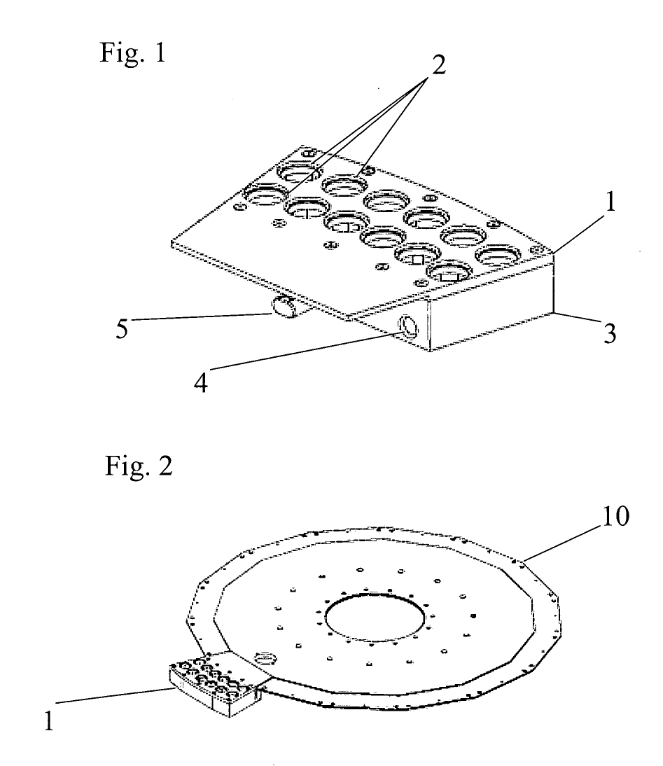

FIG. 1 shows exemplary an embodiment of a unit 1 according to the invention. This unit 1 comprises at its top side multiple openings 2 for receiving molds. Beneath this top side, a chamber 3 is located. The chamber 3 is formed such that the molds, which could be inserted through the openings 2, could be completely located in the chamber 3. The chamber 3 is used, for example, to cool down the materials in the molds of the unit 1 by means of a cooling fluid. For this purpose, the chamber 3 comprises openings 4, 5 for the inflow and the outflow of the cooling fluid in the chamber 3. In the present embodiment, at least the chamber 3 is made of a material with a low thermal conductivity.

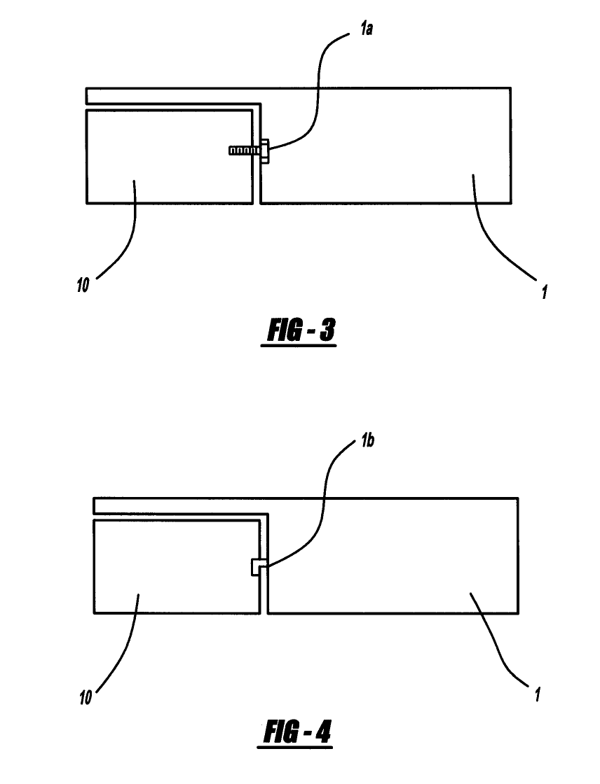

FIG. 2 shows a pour crown 10, as it may be used, for example, in connection with the molding apparatus according to the invention. The pour crown 10 and the units 1 according to the invention each comprise means in order to attach the units to the pour crown as quick as possible, as simple as possible, as firm as possible and as precise as possible.

Therefore, it is possible to substantially reduce with the subject matter according to the invention the standstill time during the exchange of molds.

1. A molding apparatus for molding materials, in particular for molding lipstick leads, wherein said molding apparatus comprises multiple molds in which said materials to be molded are cast, comprising:
said molding apparatus comprises multiple units (1), wherein in each of said units (1) multiple molds are located and
comprises means for removable fastening each of said units (1) to said molding apparatus.

2. The molding apparatus according to claim 1, wherein said units (1) are fastened to said molding apparatus by means of screws.

3. The molding apparatus according to claim 1, wherein said units (1) are fastened to said molding apparatus by means of a plug device.

4. The molding apparatus according to claim 1, wherein each unit (1) comprises at least one chamber (3) for the flowing-through of a cooling fluid for cooling said materials in said molds and each of said chambers (3) comprises openings (4, 5) for the inflow and the outflow of said cooling fluid.

5. The molding apparatus according to claim 1, wherein said units (1) are made from a material with a low thermal conductivity.

6. The molding apparatus according to claim 5, wherein said units (1) are made of plastics.

7. A unit (1) to be used in a molding apparatus for molding materials by means of molds, in particular for molding lipstick leads, wherein said unit (1) comprises multiple openings (2) for housing molds and said unit (1) comprises means for removable fastening said unit (1) to said molding apparatus.

8. The unit (1) according to claim 7, wherein said unit (1) is fastened to said molding apparatus by means of screws.

9. The unit (1) according to claim 7, wherein said unit (1) is fastened to said molding apparatus by means of a plug device.

10. The unit (1) according to claim 7, wherein said unit (1) comprises at least one chamber (3) for the flowing-through of a cooling fluid for cooling said materials in said molds and each of said chambers (3) comprises openings (4, 5) for the inflow and the outflow of said cooling fluid.

11. The unit (1) according to claim 7, wherein said unit (1) is made from a material with a low thermal conductivity.

12. The unit (1) according to claim 11, wherein said unit (1) is made of plastics.

13. A method for exchanging of molds in a molding apparatus, wherein the method comprises the following steps:
detaching from said molding apparatus units (1) attached to said molding apparatus, wherein said units (1) comprise first molds, and
attaching units (1) to said molding apparatus, wherein said units (1) comprise second molds.

14. The method for exchanging of molds according to claim 13, wherein said detaching and attaching steps are carried out by means of screws.

15. The method for exchanging of molds according to claim 13, wherein said detaching and attaching steps are carried out by means of a plug device.
